(19) United States
(12) Patent Application Publication
(10) Pub. No.: US 2014/0279053 A1
(43) Pub. Date: Sep. 18, 2014

(54) SYSTEM AND METHOD FOR APPLYING SPATIALLY INDEXED DATA TO DIGITAL ADVERTISING BIDS

(71) Applicant: DID-IT, Mineola, NY (US)

(72) Inventor: Kevin LEE, Mineola, NY (US)

(73) Assignee: DID-IT, Mineola, NY (US)

(21) Appl. No.: 13/829,335

(22) Filed: Mar. 14, 2013

(51) Int. Cl. G06Q 30/02

(52) U.S. Cl. CPC G06Q 30/0275
USPC 705/14.71

(57) ABSTRACT

A method for modifying bids on keywords used in targeted advertising including generating by one or more computers a data map made up of data representing spatially sorted information related to attributes of a plurality of users of electronic devices each located at a respective location within a space and used to access electronic media, receiving from a user computer a bid amount on an opportunity to display an advertisement through the electronic media, and automatically adjusting by the one or more computers the bid amount for each location so that display of the advertisement through the electronic media is spatially optimized based on the spatially sorted information provided by the data map.

### FIELD OF THE INVENTION

The present invention generally relates to systems and methods for generating bids on digital advertising, and in particular, to systems and method for modifying bids on digital advertising based on spatially indexed data.

### SUMMARY OF THE INVENTION

According to an exemplary embodiment of the present invention, a method for modifying bids on keywords used in targeted advertising comprises the steps of: generating by one or more computers a data map made up of data representing spatially sorted information related to attributes of a plurality of users of electronic devices each located at a respective location within a space and used to access electronic media; receiving from a user computer a bid amount on an opportunity to display an advertisement through the electronic media; and automatically adjusting by the one or more computers the bid amount for each location so that display of the advertisement through the electronic media is spatially optimized based on the spatially sorted information provided by the data map.

In an exemplary embodiment, the method further comprises the step of providing the adjusted bid amount to the user computer.

In an exemplary embodiment, the method further comprises the step of providing the adjusted bid amount to a media provider that displays the advertisement.

In an exemplary embodiment, the electronic media is accessible through the Internet.

In an exemplary embodiment, the electronic media is accessible through a set top box.

In an exemplary embodiment, the attributes of the plurality of users comprise attributes selected from the group consisting of: demographic attributes, psychographic attributes and behavioral attributes.

In an exemplary embodiment, the information represented by the data map is geospatially sorted.

In an exemplary embodiment, the information represented by the data map is spatially sorted based on network addresses within a computer network.

In an exemplary embodiment, the spatially sorted information relates to a single temporal coordinate set.

In an exemplary embodiment, the step of generating a data map comprises generating the data by searching through the locations and generating the data at each searched location.

In an exemplary embodiment, the step of generating a data map comprises generating the data based on an incoming data stream of variables used to generate the data.

In an exemplary embodiment, the step of generating a data map comprises: generating a raw data map by generating a first subset of the data corresponding to the locations within the space where direct measurement of variables used to generate the data is available; generating a second subset of the data corresponding to the locations within the space where direct measurement of variables used to generate the data is not available by estimating the second subset of the data based on the first subset; and combining the first subset and the second subset of the data.

In an exemplary embodiment, the second subset of the data is estimated using near neighbor averaging of the first subset of the data.

In an exemplary embodiment, the second subset of the data is estimated using binary sample cross validation.

In an exemplary embodiment, the second subset of the data is estimated using time series estimation.

In an exemplary embodiment, the locations are defined based on coordinates within the space.

In an exemplary embodiment, the locations are based on ZIP codes, cities, towns, counties, states, countries or combinations thereof.

In an exemplary embodiment, the step of adjusting comprises: determining a multiplier at each location based on the data map; and for each location, applying the respective multiplier to the bid amount.

In an exemplary embodiment, the step of adjusting further comprises, for each location, modifying the bid amount so as to obtain a desired average placement position for the advertisement at the location.

In an exemplary embodiment, the step of adjusting comprises: for each location, modifying the bid amount so as to obtain a desired average placement position for the advertisement at the location based on the average placement position of the bid amount prior to adjustment.

According to an exemplary embodiment of the present invention, a system for modifying bids on keywords used in targeted advertising comprises: a memory unit; one or more processors; and a computer-readable storage medium coupled to the one or more processors having instructions stored thereon which, when executed by the one or more processors, cause the one or more processors to perform a method comprising: generating by one or more computers a data map made up of data representing spatially sorted information related to attributes of a plurality of users of electronic devices each located at a respective location within a space and used to access electronic media; receiving from a user computer a bid amount on an opportunity to display an advertisement through the electronic media; and automatically adjusting by the one or more computers the bid amount for each location so that display of the advertisement through the electronic media is spatially optimized based on the spatially sorted information provided by the data map.

These and other features of this invention are described in, or are apparent from, the following detailed description of various exemplary embodiments of this invention.

### BRIEF DESCRIPTION OF THE DRAWINGS

The features and advantages of the present invention will be more fully understood with reference to the following, detailed description of illustrative embodiments of the present invention when taken in conjunction with the accompanying figures, wherein:

FIG. 1 is a block diagram showing the data structure of data included in a data map according to an exemplary embodiment of the present invention;

FIG. 2 is a representation of a normal cartographic map that may be used as the basis for a data map according to an exemplary embodiment of the present invention;

FIG. 3 is representation of a social network map that may be used as the basis for a data map according to an exemplary embodiment of the present invention;

FIG. 4 is a representation of a delivery route map that may be used as the basis for a data map according to an exemplary embodiment of the present invention;

FIG. 5 illustrates an algorithm for the construction of a data map by searching according to an exemplary embodiment of the present invention;

FIG. 6 illustrates an algorithm for the construction of a data map by classification according to an exemplary embodiment of the present invention;

FIG. 7 is a schematic diagram illustrating the data flow for the construction of a complete data map from a raw data map and other data sources according to an exemplary embodiment of the present invention;

FIG. 8 is a block diagram showing a bid modifier system according to an exemplary embodiment of the present invention and the computer environment in which the system may operate;

FIG. 9 is a user interface design diagram of a bid modifying system according to an exemplary embodiment of the present invention;

FIG. 10 is a block flow diagram showing a method for generating initial data structure for use within the bid modifying system according to an exemplary embodiment of the present invention;

FIG. 11 is a flowchart illustrating a reference keyword synchronization process according to an exemplary embodiment of the present invention;

FIG. 12 is a block flow diagram showing a multiplier buying algorithm according to an exemplary embodiment of the present invention

FIG. 13 is a flow chart showing a multiplier buying algorithm with positional correction according to an exemplary embodiment of the present invention;

FIG. 14 is a flow chart showing a multiplier buying algorithm with positional correction according to another exemplary embodiment of the present invention;

FIG. 15 is a block flow diagram showing a positional buying algorithm according to an exemplary embodiment of the present invention;

FIG. 16 is a flow chart showing a positional buying algorithm according to an exemplary embodiment of the present invention; and

FIG. 17 is a flow chart showing a positional buying algorithm according to another exemplary embodiment of the present invention.

### DETAILED DESCRIPTION OF EMBODIMENTS OF THE PRESENT INVENTION

Targeted advertising is a type of advertising whereby advertisements are placed so as to reach consumers based on various traits such as, for example, demographics, psychographics, behavioral variables (such as product purchase history), and firmographic variables. Targeting may also be based on second-order activities which serve as a proxy for consumer traits, such as, for example, tracking online or mobile web activities of consumers, associating historical webpage consumer demographics with new consumer web page access, using a search word as the basis for implied interest, or contextual advertising, to name a few.

One type of targeting advertising involves the use of addressable advertising systems. These systems are digital and addressable in that the end point which serves the ad (set-top box, website, or digital sign) is capable of rendering an ad independently of any other end points based on consumer attributes specific to that end point at the time the ad is served. Addressable advertising systems therefore use consumer traits associated with the end points as the basis for selecting and serving ads.

Some addressable advertising systems, such as Google Adwords, are CPC (Cost-Per-Click) Advertising systems, in which advertisers pay the system for every ad clicked on, irrespective of whether the person clicking the ad subsequently buys the advertised product or service. Advertisers therefore have a powerful incentive to limit exposure of their ads only to those people who are actually in-market for their product or service, and locations-based targeting provides for such a method. Geo-targeted campaigns can provide powerful advantages for advertisers seeking to run cost-efficient campaigns.

Conventional geographical targeting methods limit exposure of a given advertisement to people who are physically within a given location. Identifying the physical location of an individual Web user may be made by examining the user's IP number and associating it with a physical location. However, it is difficult for advertisers to determine the geographical areas in which they should focus their advertisements, and particularly in the case of paid search advertising, it is important to prioritize bidding parameters so as to maximize advertisement exposure to those customers that have the highest probability of purchasing the advertised product or service. In this regard, the present invention provides systems and methods that allow advertisers to modify bidding placed on keywords in an advertisement campaign, where the bid is intended for submission to a media provider that ultimately displays the advertisement over electronic media (e.g., on a webpage displayed on a computer or on a television through a set-top box), where such bid modification results in spatial optimization of the display of the advertisement. In exemplary embodiments, spatially sorted information, such as, for example, “clicks” or “conversions” indexed based on geographic location, which in turn may reflect particular attributes of a target audience, may be used as a basis to modify the original input bids. For example, systems and methods of the present invention may modify the bid on a keyword on a location by location basis so that higher bids are assigned to locations in which there is a higher probability of exposure and lower bids are assigned to locations in which there is a lower probability of exposure. The probabilities of exposure at each location may be determined by referencing a data map that provides data such as, for example, demographic, psyochographic, behavioral and firmographic data index based on location.

In exemplary embodiments of the present invention, appropriate modification of the source bids may be achieved using a variety of methods, such as, for example, applying an appropriate multiplier to the maximum bid (i.e., the maximum price on the cost of a user clicking on an ad) depending on the location, or adjusting the bids so that the ad rank (e.g., where the ad is positioned relative to other ads on the same page) is higher in the locations in which the ad is determined to have the most effect.

The locations used to index the data in the data map may be, for example, spatial coordinates, zip codes, street names, building/suite numbers, states, towns, cities and counties, to name a few. Further, data collected from smaller geographical units may be aggregated to obtain data for larger geographical units (e.g., data from all counties within a state may be aggregated to obtain total data for the state). It should be appreciated that the locations used to index the data is not limited to geographical locations. For example, the locations may be network addresses within an internet or intranet computer network or nodes within a social network or other type of online network.

Further, in exemplary embodiments, the data indexed in the data map may relate to any type of information that can be used to determine the effectiveness of an advertisement (and hence the importance of focusing funds from an advertising budget on those advertisements), such as, for example, data related to one or more of the following attributes: business/industrial vs. private consumer, residential vs. commercial, zoning information, weather, economic attributes, political attributes, property ownership, mortgage amounts, property values, religion, applicable laws and regulations, average age of automobile, primary language, ethnicity, education level, average speed of Internet connectivity, mobile phone penetration, OS penetration, interests/traits/preferences, types of energy sources/supplies, news and social feeds, to name a few. In exemplary embodiments, the systems and methods of the present invention may obtain such data from third-party sources so as to provide a dynamic and flexible tool for use by advertisers to modify their bids to optimize an advertising campaign.

More particularly, systems and methods according to various exemplary embodiments of the present invention may use proprietary logic and statistical processes on private and public marketing data to create proprietary marketing “maps” that may be used to purchase the most efficient and effective paid search advertising. The proprietary “maps” that are built may leverage location-based targeting options available from the paid search providers, such as, for example, Google and Bing, to create custom campaigns suited to fulfill specific marketing goals.

In an exemplary embodiment of the present invention, the term “data map” may refer to a collection of indexed data that has three data subsets associated with each datum. The first part is a collection of informational data that is used for modeling purposes, both descriptive and predictive; the second part is a geospatial data set that describes the location of the datum within a physical or logical space; the third part is a temporal data set that describes a period descriptive of predictive validity within calendar time or some other sequential indexing variable. The latter two parts, the geospatial data and the temporal data, comprise the indexing system for the map. The schematic structure of this collection is illustrated in FIG. 1. In particular, FIG. 1 shows each datum L0-L3 made up of the three data subsets as previously described, where each datum L0-L3 may be collected at various times T0, T1 . . . .

Systems and methods according to the present invention may be used to observe data associated with activity measured on the Internet. However, it should be appreciated that the data to be measured at each location may encompass a variety of variables and observable data. In regards to the Internet, this data may include “clicks” made on web pages to follow links to other sites or to complete actions such as interacting with data or product vendors by either sending a message or purchasing or selling goods or services etc. with the vendor, where the vendor is acting either as a principal (the person or entity selling or buying the goods or services) or as an agent (passing on orders to other persons or entities etc.). In exemplary embodiments, tracking of “clicks” and “conversions” may be used to determine behavioral attributes and/or to determine the effectiveness of ads (for example, as a feedback mechanism for modifying bids on those ads).

The spatial coordinates may be defined locations within some metric space. The space may be any topological space over which distances between coordinates may be defined. The space may be, for example, the Euclidean spaces describing geographical locations on the planet either with respect to a reference sphere or ellipsoid or in actual physical three-dimensional space. For example, FIG. 2 is a representation of a normal cartographic map as a data map.

Other spaces may be defined which do not resemble familiar geographical spaces, such as, for example, the physical or virtual topology of an internet or intranet computer network, in which locations may be defined as particular network addresses and distances may be defined in terms of the number of network segments or transmission delay times between particular locations. For example, so-called “social networks” may be represented as graphs with edges and nodes. For a social network, locations may be represented by particular members of the network and distances between members may be represented by the number of network edges linking nodes, or by effective propagation delays. Such a map is illustrated in FIG. 3.

Spaces may be defined by physical streets and addresses, not in terms of their physical geographical location but in terms of logical indexing coordinates (zip codes, street names, street numbers, building/suite numbers etc.). For example, FIG. 4 is a representation of a delivery route as a data map.

For physical spaces, such as locations on the planet defined in terms of ordinary geographical coordinates (e.g. longitude, latitude, altitude, etc.), the locations may further be defined as one or more of: single point coordinates; collections of points; line segments, defined in terms of two terminal points; collections of line segments; closed polygons, defined in terms of groups of connected line segments; and other objects typically used for geospatial location definitions.

The temporal coordinates may be defined periods of validity as described by some monotonically increasing indexing variable, such as calendar time or some other logical indexing variable such as revision number.

A single data map may be made up of a collection of data as previously described for which all members of the collection share a common temporal coordinate set. A series of maps may be made up of data maps with differing temporal coordinates arrayed in the sequence specified by their temporal coordinates. Predictive maps may be defined for sets of temporal coordinates which have not yet been observed (i.e. in the future for calendar time).

Data maps may be prepared by measuring variables of interest at a subset of the locations defined by the geospatial coordinate scheme that is suitable for the map under preparation. This subset may be equal to the entire space or it may be a causally or stochastically generated incomplete subset of the space. A map made solely by direct measurement, whether or not it fully spans the space of locations, may be referred to as a raw data map.

In exemplary embodiments of the invention, two algorithms may be used for the construction of raw data maps. The first is based on searching and the second on classification. The searching algorithm involves preparing a set of locations within the space to visit. This set may be computed by enumerating all possible locations; by starting at a given fixed location and exploring neighbors progressively; or by randomly generating a set of locations to examine. At each location, measurements of the data of interest are recorded together with their location data and temporal data. This generated data set consists of a raw map created by searching. FIG. 5 illustrates an algorithm for the construction of a data map by searching in which a number of locations L0, L1, L2, L3 . . . are first defined and then analyzed in sequence to determine the appropriate data at each location.

The classification algorithm involves defining a procedure in which observations of an incoming data stream are made and each datum is classified according to assigned location and temporal index variables. The data set created by this method consists of a raw map created by classification. This algorithm is illustrated in FIG. 6 in which incoming datum is located (Li), measured (Di) and then stored.

The following example is provided to show how raw data maps may be generated.

### Example 1

The procedure for generating a raw data map described in this Example is based on a classification algorithm. In particular, the algorithm is used to produce a raw data map of the “conversion rate” of all internet shoppers in terms of their geographical location in which the computer they use to make a purchase of goods or services is located and the likelihood of a purchase made by a computer user in that location.

A “conversion” may be defined as a set of actions in which a computer user clicks on a link on a web site which offers goods or services, such as a link to a product vendor that is offered to the user when the user searches for a particular product on a web site that indexes such data (such as the Google search page), and then subsequently follows through on that action by actually purchasing items from the vendor whose link was displayed and was initially clicked upon.

Several maps may be produced by filtering the observed set of uses in terms of the business sector of the vendor, or specific individual vendor, that provided the links which were followed. In addition, an unconditional map may be produced which aggregates all interactions irrespective of business sector or specific vendor. All of these maps are prepared via the procedure outlined below. Maps may also be produced by filtering the identity, or possibly imprecise knowledge of the identity, of the computer user and describing the interactions of that user, or a set of similar users based on some geospatial, spatio-temporal, or demographic classification, with all of the sites the user(s) interacts with.

When the computer user interacts with the vendor's online business, both in terms of the initial “click” on the offered link and the subsequent “conversion” that occurs when the user purchases goods or services from that vendor, either directly with the vendor acting as a principal or indirectly with the vendor acting as an agent for a third party, data is collected with respect to the internet network address of the computer being used to initiate the actions. This data is used to look up a likely physical location of the computer in terms of the “ZIP Code” area it is located within. ZIP codes are postal delivery regions and are physical spaces defined by distinct closed polygons that form their perimeter. These polygons may not necessarily be simply connected figures, meaning that they may include holes or physical regions that are assigned to different ZIP codes. These polygons form a complete tiling of the inhabited geographical space of the United States, meaning that there are no inhabited regions that do not have a ZIP code assigned (excluded regions are, for example, bodies of water that are not inhabited.) The assignment of a computer location to a ZIP code may be done via interaction with an API of a third party database vendor and the assigned ZIP code is the output of that interaction. The network address is associated solely with a single ZIP code, even if the assigned ZIP code is entirely enclosed within another distinct ZIP code.

The “conversion rate” for the ZIP code is defined as the ratio of the number of initial clicks observed for a given ZIP code to the number of conversions observed for that same ZIP code. This observed conversion rate is a statistical estimator of the probability that a given internet shopper located within that region may complete a purchase given that such a shopper initiated an interaction by clicking on one of the links that was offered to the shopper by the search site. Other information about the action, such as shopping cart size or contents or value of goods purchased, may also be associated with the shopper.

A single temporal instance of the conversion rate map indexed by ZIP code is prepared by assembling a database of all clicks and conversions that occurred within a given time frame, for example all of those that occurred within a particular calendar month. Other temporal instances of the conversion rate map indexed by ZIP code may be prepared. As described in more detail herein, several raw data maps, with distinct temporal indices, are used to form a complete data map.

Data is collected from the “clicks” and “conversions” produced when internet users interact with online advertisements and stores. The data is a set of records that includes: date and time, IP protocol address of the computer initiating the interactions, a status variable indicating whether the record was a “click,” a “conversion” or some other interaction; and additional data that is available for use. Stored with this data is a “weight” value, a non-negative real number, which may be used to qualify or select the data.

In this Example, the IP number is used to look up geolocation information associated with each computer at the time of the interaction by calling an API provided by a geolocation database vendor. This vendor may be a third party or in-house. This information includes the ZIP Code, if available, and estimates of the longitude and latitude associated with the IP number.

These data rows are assembled into a table in a database system for subsequent processing.

The collected data are divided into two samples by computing the extreme dates and times for the entire set and dividing the set into two parts by computing a mid-point in time half-way between the earliest sample and the latest sample. This midpoint is not computed to ensure the same number of events exist in each sample. An alternate method would be to compute the midpoint such that it equally divides the data samples and represents the median date and time for the collected data.

With a large sample of data, in excess of one million rows may be collected, and summary statistics are computed. Alternately, smaller or larger samples might be used, although the statistical fluctuations in smaller samples would be larger.

For each sample the summary statistics are collected by counting the number of “clicks” and number of “conversions” observed with a given ZIP code, for all ZIP codes active within the United States, for all events with “weight” greater than or equal to zero. This may be performed by simple counting, or by using a relational database for storage and the “SELECT . . . GROUP BY . . . ” operation provided by that system to implement the counting algorithm. The output is a tally table with columns of ZIP code, number of “clicks,” number of “conversions,” and “conversion rate” defined to be the simple ratio of the number of “clicks” (which includes all interactions whether or not they are “conversions”) to the number of “conversions.” Alternately, if “clicks” and “conversions” are stored as exclusive data, such that a record is either a “click” or a “conversion” but not both, then it would be the ratio of “conversions” to “clicks” plus “conversions.” This result is computed as a real number and stored as the fraction “conversions” divided by “clicks.” This fraction represents an estimate of the probability that a given “click” will generate a “conversion” for a computer located in a particular ZIP code where the estimate is computed by measuring the observed rate within each ZIP code. Alternately, instead of using ZIP codes, some other locating region such as a grid of coordinate points or polygons (expressed in “latitude” and “longitude” or other physical coordinate), a “state,” “county,” “city,” “census tract,” “block,” “street,” “building,” or any other available aggregating variable may be used for counting.

The output tally tables are stored for further processing, or may be used directly to estimate conversion rates for ZIP codes, or other aggregating unit, in which the data is expressed.
* * *

Raw data maps produced either by the classification or searching algorithms described above may not contain data for all of the indexing locations within the map that are of interest. A data map that does include information relevant to every indexing location of interest may be referred to as a complete data map. Complete data maps are produced by processing one or more raw data maps to estimate the values that should be observed at locations that are not available from the raw data maps. Several algorithms may be used to “fill in” missing data by estimating the values that should be observed in those locations via statistical procedures. FIG. 7 is a schematic diagram illustrating the data flow for the construction of a complete data map from a raw data map and other data sources. In particular, FIG. 7 shows a representation of an algorithm defined to process data in such a manner that the end result will be a complete data map. The input data may be composed of several raw maps: a map of conversion rates such as that described in the example above; a map of demographic data; and, maps made from other sources. The raw map is incomplete and so it is necessary to estimate the values that are predicted to be observed at locations that have not been directly observed. One way to make this prediction is via an interpolation method, such as near neighbor averaging or other methods. To make the most accurate prediction in an unobserved future data set it may be informative to compute a “Bayesian Blend” of interpolated data and actual measured data where it exists. This is a linear combination of values from the interpolation procedure discussed above and the actual direct measurements. Since direct measurements may contain errors it may be found that this mixture leads to more accurate predictions than the direct measurements alone. This data is combined via mathematical procedures with data drawn from other sources, such as demographic maps, to produce a final predictive model. The predictive model is then compared with actual direct measurements drawn from a raw data map. The degree of “fit” or accuracy of the predicted model may be assessed through an empirical risk function that measures the aggregate accuracy of the predictive model. If the predictive model has freely adjustable parameters, an optimization method may be used to choose those parameters in such a manner that the empirical risk function is sent to an extremum. The parameter set chosen may then be used with the predictive model to compute the values of the rendered complete data map for every indexing coordinate of interest.

One method that may be used to generate a complete data map includes the use of near neighbor averaging. According to this algorithm, for every location in the complete data map a group of “nearby” locations is defined by enumerating all locations within a given spatial distance of the location of interest. This set might include the entire map space or it might only include a subset of those regions defined as those with a location less than a particular distance (where distance is defined by the particular metric used by the map under preparation). Each location for which data is present in the raw data map is assigned a weight based on their distance to the point of interest and the value of the data for the complete data map at that location is computed as the weighted average of the values observed within the raw data map. The averaging method may be a simple arithmetic mean, a weighted mean, a simple or weighted median, or a more complicated method such as “kriging” which is defined as the weighting method that produces the smallest mean-square errors in expectation under specific assumptions.

Another algorithm that may be used to generate a complete data map is based on binary sample cross validation. According to this method, an “A” sample raw data map and a “B” sample raw data map are defined. These samples are raw data maps with distinct temporal indices. They do not have to have sequential temporal indices, but they may do so. For example, an interleaving method may be defined in which all data observed on an even calendar day number is assigned to raw data map “A” and all data observed on an odd calendar data number is assigned to raw data map “B.” A sequential method may also be defined in which all data observed in a single calendar period, such as a month or year, is assigned to raw data map “A” and all data observed in a subsequent calendar period, of similar or different temporal size, is assigned to raw data map “B.”

In this method each raw map may or may not contain data for a given spatial location. When both raw maps do contain data for a given spatial location, a linear combination of the observed data for the location and the near neighbor average data for the location in one raw map is compared to the observed data in the alternate raw map. Both comparisons, i.e. “A” vs. “B” and “B” vs. “A” are made. An empirical risk minimization (ERM) procedure is used to find the linear mixture parameter that best describes both maps jointly. When the measured data is not drawn from a well known probability distribution then a least-squares procedure is used for ERM. When the data is drawn from a well known probability distribution, such as the Poisson distribution for observed “event” rates such as “clicks” and “conversions,” then a maximum likelihood procedure is used.

Computation of the complete map occurs after the “best” estimate of the linear mixture between direct observations and near neighbor average observations is determined as described above. This combination may be referred to as a “Bayesian Blend” of direct observations and near neighbor averages. The method is to examine the locations within the raw data map computed as the union of the “A” map and the “B” map. Wherever data is observed in the union map the complete map value is taken to be the estimated best mixture of the direct observations from the raw map and the near neighbor estimates from the averaging procedure. Wherever no data is observed in the raw map the complete map value is taken to solely be the value computed from the near neighbor estimates from the averaging procedure.

Another algorithm that may be used to generate a complete data map may be based on a time series estimation. When multiple raw data maps are indexed in a temporally sequenced manner, a time-series estimation algorithm may be defined as follows: For each map at a given temporal index, the values at all raw map locations for which data is observed is predicted as a combination of direct raw map observations and near neighbor averages from all prior raw maps. The particular mixture may be determined by empirical risk minimization procedures such as least-squares or maximum likelihood as before. The final complete map is then specified as the particular combination of prior raw maps that is output by the ERM procedure.

The enumeration of near neighbors for near neighbor averaging may involve extensive computation. In this regard, a method for the rapid computation of candidate neighbors may be defined based upon the first three digits of the ZIP Code associated with each location within the map. This method requires substantially less computation and may be done rapidly. The first three digits of a five digit ZIP code represent a regional service center as defined by the US Postal Service. The last two digits represent a particular delivery region serviced by each regional service center. The delivery regions are generally spatially contiguous, although they need not be. Therefore the “Z3” neighbor regions may be defined as all of those within a map that share the common first three digits of the ZIP code. This method efficiently locates all ZIP codes within large geographical areas, such as a particular city, very rapidly. For each given ZIP code, using this method, a near neighbor average may be computed from the raw map locations with the first three digits of the ZIP code matching that of the region under consideration. These near neighbor averages are then used as an input to the various procedures for the production of complete data maps as described above. The weighting system assigned to the neighbor regions under this procedure may be defined to be given by the mathematical function e^{-1/2t}^{²}, where t is the ratio of the distance from the neighbor location to the location for which the average is being computed to the average of all of those distances within the set of ZIP codes sharing the same state as the ZIP code for which the complete data map is being examined. This scaling procedure takes account of the fact that ZIP codes may be substantially more geographically dispersed in some states, e.g. New Mexico, than in others, e.g. New Jersey.

The following example is provided to show a specific algorithm for the production of a complete map for ZIP codes based on a ZIP code “3 digit” average.

### Example 2

The tally table produced in Example 1 may be used as the data source for the computation in this example.

All regions with ZIP codes within the United States are enumerated. These are referred to as the “target” ZIP codes.

For each target ZIP code enumerated, all ZIP codes for which the first three digits match and conversion rates are measured in the tally table are enumerated and associated with the target ZIP code. These are referred to as the “averaging” ZIP Codes.

For each data sample prepared in Example 1 the tally table for each target ZIP code is augmented with an entry that represents the distance weighted average of the conversion rates measured for all of the associated averaging ZIP codes that have entries. The formula used for the distance weighted average is that discussed in Example 1. For each ZIP code that does not have an entry in the tally table but does have a defined distance weighted average a new entry is added to the tally table with a marker for “not available” for the actual measurement and with the appropriate distance weighted average.

Two such tally tables are prepared, one for each data sub-sample, and are referred to as “A” and “B.”

As we are measuring count rates the maximum likelihood estimation procedure is used to estimate the cross-validating conversion rates. An adjustable parameter φ is introduced. If a tally table entry of the measured conversion rate exists for the given zip code, the expected conversion rate R_{Z} for a given target ZIP code z may be modeled as follows:

R_{Z}=φM_{Z}+(1−φ)A_{Z} (1)

where,

M_{Z}=the measured conversion rate of a tally table entry for the given zip code, and

A_{Z}=the distance weighted average conversion rate.

If no tally table entry exists for the target zip code, then the distance weighted average is used alone, so that:

R_{Z}=A_{Z} (2)

For a given expected conversion rate, R_{Z}, the log-likelihood of a particular measurement of the number of conversions given a particular associated measurement of the number of clicks, is given by:

X_{Z} ln C_{Z}R_{Z}(φ)−C_{Z}R_{Z}(φ)−ln X_{Z}! (3)

where,

X_{Z}=a particular measurement of the number of conversions, and

C_{Z}=number of clicks.

For the tally table prepared from data sample “A”, the measurements from that table, X_{Z|A} and C_{Z|A}, and the modeled rate from data sample “B,” R_{Z|B}, are used. For the tally table prepared from data sample “B”, the measurements from that table, X_{Z|B} and C_{Z|B}, and the modeled rate from data sample “A,” R_{Z|A}, are used.

To jointly determine the value of φ that best predicts the observed rates in each sample, a log likelihood objective function may be formed by summing over all target ZIP codes for which measurements exist as follows:

$$L ( φ ) = {\sum }_{z} \{ {X}_{z \vert A} ln {C}_{z \vert A} {R}_{z \vert B} ( φ ) - {C}_{z \vert A} {R}_{z \vert B} ( φ ) + {X}_{z \vert B} ln {C}_{z \vert B} {R}_{z \vert A} ( φ ) - {C}_{z \vert B} {R}_{z \vert A} ( φ ) \} \qquad ( 4 )$$

The terms in the log of the factorial of the number of conversions, X_{Z}, are not included in this sum as they are independent of φ and merely contribute an additive constant.

The function defined by equation (4) varies smoothly with φ and has a maximum at the value that composes the mixture between the direct observations at each target ZIP code and the distance weighted average for that ZIP code that best predicts the observed conversion rate in the alternate sample.

To numerically determine the particular value of φ that maximizes the log likelihood objective function L(φ), the Conjugate Gradient search method using the algorithm developed by Broyden, Fletcher, Goldfarb and Shanno, commonly referred to as “BFGS,” may be used. Alternately, other algorithms may be used to find this value, such as the method of Berndt, Hall, Hall and Hausman (“BHHH”) or Newton's method of Steepest Ascent, or the Simplex Algorithm of Nelder and Mead, or exhaustive search, or random search, such as those methods referred to as The Metropolis Algorithm or Simulated Annealing or other similar numerical optimization procedures.

As an alternative, a so-called “least squares” objective function may be minimized as follows:

$$SS ( φ ) = {\sum }_{z} [ {\{ {X}_{z \vert A} - {C}_{z \vert A} {R}_{z \vert B} ( φ ) \}}^{2} + {\{ {X}_{z \vert B} - {C}_{z \vert B} {R}_{z \vert A} ( φ ) \}}^{2} ] \qquad ( 5 )$$

or alternately

$$SS ( φ ) = {\sum }_{z} [ {\{ {M}_{z \vert A} - {R}_{z \vert B} ( φ ) \}}^{2} + {\{ {M}_{z \vert B} - {R}_{z \vert A} ( φ ) \}}^{2} ] \qquad ( 6 )$$

or the “least chi-squared” objective may be minimized as follows:

$${χ}^{2} ( φ ) = {\sum }_{z} [ \frac{{\{ {X}_{z \vert A} - {C}_{z \vert A} {R}_{z \vert B} ( φ ) \}}^{2}}{{C}_{z \vert A} {R}_{z \vert B} ( φ )} + \frac{{\{ {X}_{z \vert B} - {C}_{z \vert B} {R}_{z \vert A} ( φ ) \}}^{2}}{{C}_{z \vert B} {R}_{z \vert A} ( φ )} ] \qquad ( 7 )$$

or alternately

$${χ}^{2} ( φ ) = {\sum }_{z} [ \frac{{\{ {X}_{z \vert A} - {C}_{z \vert A} {R}_{z \vert B} ( φ ) \}}^{2}}{{X}_{z \vert A}} + \frac{{\{ {X}_{z \vert B} - {C}_{z \vert B} {R}_{z \vert A} ( φ ) \}}^{2}}{{X}_{z \vert A}} ] \qquad ( 8 )$$

or similar expressions any of which should converge to equivalent solutions but which may have larger sampling errors for small samples.

Having determined the best estimate of φ, an estimated map of expected conversion rates can be created by aggregating the conversion and click counts for both sample “A” and sample “B” and using the formulae for Rz in terms of Mz and Az and φ as established above; or some other mixture of the samples may be used. As the data sample of the fully aggregated data is higher than the individual subsamples the chances of there existing target ZIP codes for which no possible estimate may be made, because both Mz and Az are not observable due to small samples sizes, is reduced and the resultant Complete Map has estimates for all or almost all target ZIP codes.
* * *

A neighbor enumeration procedure may also be defined based on reference ellipsoid radial distance. Geographical Information System (GIS) may be used to compute sets of ZIP codes based upon the distances of their centroids to that of each ZIP code for which the near neighbor average needs to be computed. This distance may be defined to be the “great circle distance” on the WGS84 reference ellipsoid for the planet between the centroids of the ZIP codes under consideration. The cutoff radius may be taken to be the average ZIP code to ZIP code distance within the state of the ZIP code for which the average is being computed, as in the procedure described in Example 2, or it may be taken to be an arbitrary distance such as 100 miles, or it may be determined as the “best” distance to use following an empirical risk minimization procedure such as the binary sample cross validation or time-series estimation as previously described. The weighting and estimation procedure uses the same formula as discussed in Example 2. For this procedure the number of “averaging” ZIP codes for a given “target” ZIP code will be larger as the radial procedure does not follow State, County or other geographical boundaries in the way that the three digit similar ZIP codes do. However, apart from the different selection of averaging ZIP codes for a given target ZIP code, there are no other differences in the implementation of the algorithm.

To compute the observations of clicks, conversions and conversion rates for geographic regions, such as cities, counties, states etc., that are larger than those for which the underlying raw data maps, based on ZIP codes, are defined, the observations may be aggregated based upon individual ZIP codes for all ZIP codes that are defined to be within the larger geographic area. This aggregation may be done by summation of the individual click and conversion counts and by computation of the ratio of the sums for the conversion rates.

For the procedure based on the three digit ZIP code averages, an average over all ZIP codes that are neighbors of all ZIP codes that exist within the larger geographical region may be determined. For example, suppose a city contains ZIP codes from two sets 011xx and 012yy. An average over all ZIP codes for both three digit prefixes would be determined. For the procedure based on the fixed geographical radius, a GIS may be used to find all ZIP codes that are within the cutoff distance of the centroid of the city, county, or state under consideration.

The binary sample cross-validation or time-series estimation procedures described previously for single ZIP code estimates may be used to discover the best mixture of direct raw map observation and near neighbor averages to use for the output of the complete data map for larger geographical regions.

In exemplary embodiments, a method for the production of a map of conversion rates for a city may be based on the statistical method of “Generalized Linear Models” and incorporating other, non-count rate based, data. A Generalized Linear Model is a model in which the predicted variable is mapped through a link function to an underlying linear predictive formula rather than being directly expressed in terms of the linear predictive formula. This link function is required to be a monotonic increasing function of the argument. For the purposes of this algorithm, a “squash” function may be defined as a link function defined by the formula

squash(χ;φ)=(φ(1−e^{-χ/φ}) (9)

This function may be used to model conversion rate data in which there are errors skewing the estimates upwards from their true values due to the statistical fluctuations of small count rates. The function smoothly limits the upper value of the response to the argument x. Alternate functions that perform similarly and may also be used in the method are the logistic function, the hyperbolic tangent function, the square root function, the natural logarithm and other functions with similar shapes.

For example, this function may be used to transform a model which predicts the conversion rate for a given city in terms of the following variables: a constant uniform conversion rate; a variable expressing a radial average conversion rate measured by the methods described above for the ZIP codes within a defined radius of the ZIP codes that are contained within the city; a variable expressing the logarithm of the per capita income of the residents of that city.

The per capital income may be measured by summing the Adjusted Gross Income reported by the Internal Revenue Service in their published summary data files for each ZIP code contained within the city. This is divided by an estimate of the population of the same areas obtained by, for example, summing the number of tax returns filed, the number of joint returns filed, and the number of dependents listed on those returns.

The final expression for the predicted conversion rate for the city in sample “A” is

R_{i|A}=squash(α30 βA_{i|A}−γLᵢ;φ). (10)

where,

A_{i|A}=the radially averaged measurement of the conversion rate for the city,

Li=the log of the measured per capita income for the city,

R_{i|A}=the predicted conversion rate, and

α, β and γ represent adjustable parameters that are chosen by estimation procedures to adjust the predictions to obtain the most predictive skill for the data sample.

Values for α, β and γ may be obtained by minimizing an empirical risk function computed from the predicted conversion rate and the observed conversion rate within the sample using the least squares objective function:

$$SS ( α , β , γ , φ ) = {\sum }_{i} {( {M}_{i \vert A} - {R}_{i \vert A} )}^{2} \qquad ( 11 )$$

which may be minimized by the methods discussed. Alternately, any of the other previously-described empirical risk functions may be used.

These predictions may be cross-validated to ensure model prediction accuracy by comparing the conversion rates computed by using the discovered parameter values from the “A” sample and the observed average conversion rates from the “A” sample with the actual observed city specific conversion rates in the “B” sample. This comparison may me made by performing an ordinary linear regression of the direct observations made in the “B” sample onto the predictions made from the data in the “A” sample. If the model is accurate, this ordinary linear regression should have an intercept term statistically indistinct from zero and a slope term statistically indistinct from unity. In this context, “statistically indistinct” may mean having a computed “t” statistic for the distance from the expected value of less than 3. Models which do not satisfy this criterion may be either rejected or augmented with additional variables until a model which satisfies the criterion is found.

FIG. 8 is a block diagram showing a bid modifier system, generally designated by reference number 1000, according to an exemplary embodiment of the present invention and the computer environment in which the system 1000 may operate. In this regard, exemplary embodiments of the method according to the present invention are implemented on a system that includes one or more computers including one or more memory units, one or more processors and one or more non-transitory computer readable storage media including computer-readable instructions that are read by the one or more processors to execute the various steps and algorithms of the methods described herein. Exemplary embodiments of the invention may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of one or more such back-end, middleware, or front-end components.

In an exemplary embodiment, the system 1000 may include a web server 1010 that allows a user to select the keywords they would like to run through the system 1000 as well as basic reporting to show what volumes of impressions, clicks and spend is running through the system 1000, as well as performance of the keywords that have been cloned by the system 1000 (as explained in more detail below). The system 1000 may be accessed via the internet 1020 by any device 1012 that supports a standard web browser, such as, for example, a smartphone, a desktop computer or a laptop or other type of portable computer. The system 1000 may also include a backend system management component 1020 that houses the necessary data to construct maps, interface with supported media providers through API's (Application Programming Interfaces) and house the necessary data needed for the user interface to function properly.

In this regard, the system management component 1020 may include a server 1022 and a storage component 1024. The previously-described map creation process involves the use of data that is pulled from various sources 1030 such as third party data providers, government data sources (census, etc.) and from proprietary systems. This data can be stored in multiple formats and accessed from, for example, databases, API's and flat files. Once a map is created and uploaded into the system 1000, it can be applied to any account that has been linked with the system 1000. The system 1000 may interact with media providers 1050, such as Google, via an API 1040 through the internet 1020 to create the necessary structures in the media provider based on the associated map and to also apply the appropriate bidding and buying logic defined by the map and executed by the system management component 1020 of the system 1000.

FIG. 9 is a user interface design diagram of a bid modifying system according to an exemplary embodiment of the present invention. In this regard, end users of the system 1000 may have access to a user interface that will allow them to browse their media accounts 2150, which are linked with the system 1000, and select the keywords that they would like to run through the system 1000. The system 1000 may be a secure system using standard internet security protocols when logging in through a secure login page 2100, giving the user access to a main navigations page 2110 to perform all of the required tasks. System users may have the ability to choose from any number of linked accounts 2120 and any number of maps 2130 associated with those accounts. Once those elements are chosen the end user may have the ability to choose the keywords 2150 they want to have running through the system 1000 and receive notifications 2140 of actions and messages from the system 1000. The end user may also have the ability to manage certain aspects of the campaigns 2160 ran through the system 1000, such as daily keyword budgets, targeting and distribution settings (determined by what is available from the media provider), as well as removal of keywords from the system 1000.

End users may also have the ability to pull reports out of the system interface 2180, consolidating key performance indicators, such as spend, impressions and clicks of the reference keyword as well as aggregations of the system reference keyword clones in one cohesive report.

The system 1000 may also have an administration section 2170 that allows the end user to change their password as well as any function required to manage their user information. Systems administrators may have access to functions within the administration section to manage (add/edit/delete) maps within the system, manage the linkage of engine accounts to maps and other system functions such as changes to buying algorithms as they are implemented.

The system 1000 may create the necessary structures (campaigns, adgroups, keywords, etc.) based on the map file that was associated to the engine account when keywords were added within the system user interface. The system 1000 may also maintain a synchronization of key elements of the reference keyword, such as, the ad's message and the status, paused or active, the landing page, and the reference keyword's max bid amount, which may be used as a reference for certain buying algorithms.

FIG. 10 is a block flow diagram showing a method for generating initial data structure for use within the system 1000 according to an exemplary embodiment of the present invention. To add keywords into the system 1000, a user may log into the system 1000 via a web browser, select the account they want to work with and select an associated map that has been loaded into the system 1000. The user may then browse the account, viewing the source structures 3000 that currently exist in their media account. The user may browse through the campaigns 3010 that make up the source structures 3000, including ad groups 3012, ads 3014 and keywords 3016, and select any keywords 3016 they want to run in the system 1000. Once the keywords are selected to run through the system 1000, the user may start an initialization process. The initialization process may reference the map associated with the account and create the necessary data structures 3020, including system campaigns 3030, which are set to target specific geographic regions based on the map and specific targeting and distribution settings that are allowed by the media provider, and system ad groups 3032, which may be given a unique name by the system 1000 and which house the cloned keywords 3036 and advertisements 3034. Once these structures are built, the system may clone the reference keyword advertisements 3014 into the cloned ad groups 3032 and the system 1000 may create cloned keywords 3036, with their respective landing page URL's into the cloned ad groups 3032. Once all of the necessary structures are built and all required cloned entities are created, the system 1000 may activate the keywords in the media source.

The system 1000 may have a mechanism in place that continuously checks the reference keywords key entities, such as the active advertisements, the current max bid and the landing page the keyword is going to. If any of these entities have changed on the reference keyword, the modification that was made to the changed entity may be applied to all of the cloned ad groups and keywords. Any changes made to the reference keyword max bid are stored in the system 1000 and may influence the bid that is applied to the cloned keywords, based on the buying algorithm that is currently running for a particular map.

FIG. 11 is a flowchart illustrating a reference keyword synchronization process according to an exemplary embodiment of the present invention. In step S01, the process is started. In this regard, the synchronization process may run as frequently as needed or may be manually initiated. In step S03, the media source is queried to extract all location-based structures, keywords and ads. Through an automated mechanism, the system 1000 may connect with the media source and extract all of the campaigns, ad groups, keywords, ads and negative keywords that are classified as system location-based structures through their naming convention. In particular, to differentiate structures (e.g., campaigns and adgroups) generated by the system 1000 from original source structures, the system 1000 may name each created campaign and adgroup using a defined naming convention (e.g. a system reference ID).

In step S05, the system 1000 may load in associated maps for the given account. Based on the specific account being reviewed, the system 1000 may pull the maps that will define what structures should exist in the media source and what are the necessary bid values for the location-based keywords.

In step S07, the system 1000 may load reference keywords associated with the account. Based on the specific account being reviewed, the system may pull what keywords exist in the system and what maps are associated with them. This will inform the system 1000 what keywords should exist in the structures that are created from associated maps.

In step S09, the system 1000 may construct expected media source structures with ads, keywords and negative keywords. In this regard, the system 1000 may build in memory what the expected structures should be in the media source based on the maps and keywords in the system 1000.

In step S11, the system 1000 may check the structure (campaigns and ad groups), keywords, ads and negative keywords that currently exists in the media source and compare it to what is expected to exist in the media source.

In step S13, it is determined whether all expected location-based campaigns exist. If no, process flows to step S15, where, using automated or manual methods, the system 1000 may create the campaigns that should exist in the media source.

If it is determined in step S13 that all expected location-based campaigns exist, process flows to step S17, where it is determined whether all expected location-based ad groups exist. If no, process flows to step S19, where, using automated or manual methods, the system 1000 may create the ad groups that should exist in the media source.

If it is determined in step S17 that all expected location-based ad groups exist, process flows to step S21, where it is determined whether all expected location-based ads exist. If no, process flows to step S23, where the system 1000 may check to see that the current state of the ads that exist for the reference keywords are represented in all of the required location-based structures. If ads are missing the system 1000 may create the location-based ads, if ads are paused or active the system 1000 may make the location-based ads paused or active and if there are deleted ads, the system 1000 may delete the location-based ads.

If it is determined in step S21 that all expected location-based ads exist, process flows to step S25, where it is determined whether all expected location-based negative keywords exist. The system 1000 may check to see that the current negative keyword set associated with the reference keyword is represented in the location-based structures. In step S27, if a negative keyword is not represented in any location-based structure, the negative keyword may be added, or if there is a negative keyword in a location-based structure that no longer exists in the reference structure, then the negative keyword will be deleted from the location-based structure.

If it is determined in step S25 that all expected location-based negative keywords exist, process flows to step S29, where the system 1000 may check to see that all of the required location-based keywords exist and have the correct status, landing page and bid values based on the map and reference keyword set. If no, process flows to step S31, where, if a location-based keyword no longer has a reference keyword, the system 1000 may delete all instances of that keyword from the location-based structures. If a location-based structure does not have a keyword and is expected to, the system 1000 may create the keyword in the necessary location-based structures. If the status of the reference keyword is active or paused, the system 1000 may ensure all location-based keywords associated with the reference keyword have the same status. If the reference keywords landing page URL is different then the location-based keyword, the system 1000 may change the location-based keyword to have the same landing page URL as the reference keyword. Based on the map and the set purchasing algorithm the system 1000 may make sure the location-based bid is set to the proper value.

If it is determined in step S29 that all required location-based keywords exist and have the correct status, landing page and bid values, the process ends at step S33.

The system 1000 may make buying decisions on the cloned keywords based on the map that is associated with the account and the buying algorithm configured to run. In this regard, the system 1000 may have two major types of buying algorithms. One algorithm is based on a multiplier that uses the reference keywords maxbid to indicate how much the cloned keywords should be bid to. The other is a positional buying algorithm that leverages the positional nature of a paid search marketing program that allows the system to determine what position in a list of advertisements the ad should show up (i.e., how the advertisement is ranked compared to other advertisement in terms of display priority) based on a set maximum bid amount on a given keyword. Both of these algorithms may have a caveat that factors in the information from the reference keyword to make smarter buying decisions as well as potential feedback into the system from third party tracking systems.

FIG. 12 is a block flow diagram showing a multiplier buying algorithm according to an exemplary embodiment of the present invention. The multiplier buying algorithm may use the current reference keywords max bid from a source structure 4000, which includes an associated source campaign 4010, ad groups 4012, ads 4014 and keywords 4016, as well as the designated multiplier defined in the map 4020, to determine the correct max bid for each of the respective system campaigns 4030 and keywords 4040 that exist. The map may instruct the synchronization and buying algorithm processes to set the cloned keywords 4040 based on their definition in the map and what the reference keyword's max bid is currently set to.

FIG. 13 is a flow chart showing a multiplier buying algorithm with positional correction according to an exemplary embodiment of the present invention. According to this method, the system 1000 may ensure that that it is not overpaying for any given cloned keyword by lowering cloned keyword bids until the serve in an average position of 1.1, or some other value that is greater than 1.0. A goal of this algorithm is to isolate and minimize any overly aggressive maxbids based on the multiplier. Serving in position 1.0 would be ideal for regions that are deemed the best, but at the same time it may be important to avoid overpayment for top positions. In step S101, the process starts and proceeds to step S103, where the media source is queried to attain average position and bid of a reference keyword. The bid of the reference keyword may be used to determine the bid of the location-based keywords that are generated from the map.

In step S105, any active maps are checked for geo segments and required bid multipliers. In this step, the system 1000 may check to see what maps are currently active for a given account and use the bid multipliers that are associated with each defined geo segment and apply to the keywords within the geo segment.

In step S107, the media source may be queried for required location-based keywords and bids. Through automated or manual methods, the current bids of the reference keywords and all of the location-based structures and keywords that should exist based on the maps configurations may be retrieved.

In step S109, it is determined whether necessary keywords exist. In this regard, the system 1000 may check to see that all of the defined structures and keywords exist in the media source. If not, process will flow to step S111, where the system 1000 may create the structures and keywords either through an automated method or create an output that can be used for manual implementation.

If it is determined in step S109 that necessary keywords exist, process flows to step S113, where location-based keyword bids may be set by using the reference keyword bid and map multiplier. The system 1000 may use the reference keywords bid as the basis for the associated location-based keyword bids. Each location-based structure may have a bid multiplier associated with it and when the system locates keywords within a given location-based structure it will refer to the map to determine the bid multiplier to apply to the keyword. Once the correct multiplier is located the system 1000 may find the reference keyword bid and multiply it by the set multiplier to determine the necessary bid for the location-based keyword.

In step S115, it is determined whether the average position is 1.0. In this step, the system 1000 may check to see if the bid of the location-based keyword puts it into an average position of 1.0. If so, the system 1000 may try to find a more efficient bid to attain similar outcomes by lowering the bid until the average position becomes 1.1, at which point the process ends at step S119.

If it is determined in step S115 that the average position is not 1.0, the process ends at step S119.

FIG. 14 is a flow chart showing a multiplier buying algorithm with positional correction according to another exemplary embodiment of the present invention. In this embodiment, the system 1000 may use a bid multiplier associated with the map as in the previous embodiment, but instead of using the reference keyword as the max bid reference amount, the reference amount is specified by the user. In step S201, the process starts, and proceeds to S203 where the system 1000 queries the media source to attain average position and bid of reference keyword. The bid of the reference keyword may be used to determine the bid of the location-based keywords that are generated from the map.

In step S205, any active maps are checked for geo segments and required bid multipliers. The system 1000 may check to see what maps are currently active for a given account and use the bid multipliers that are associated with each defined geo segment and apply to the keywords within the geo segment.

In step S207, the system 1000 may query the media source for required location-based keywords and bids. In this regard, through automated or manual methods, the current bids of the reference keywords and all of the location-based structures and keywords that should exist based on the maps configurations are retrieved.

In step S209, it is determined whether necessary keywords exists. In this step, the system 1000 may check to see that all of the defined structures and keywords exist in the media source. If no, process flows to step S211, where the system 1000 may create the structures and keywords either through and automated method or by generating an output that can be used for manual implementation.

If it is determined in step S209 that necessary keywords exist, process flows to step S213, where the system 1000 may determine if there is a disassociated reference keyword bid. In this regard, the system 1000 may allow an override bid value to be used instead of the reference keyword's bid value. The override bid may be set manually via the user-interface, or can be done using automated methods.

In step S215, it is determined whether a reference bid override exists. If no, process flows to step S217, where the location-based keyword bids may be set by using the reference keyword bid and map multiplier. The system 1000 may use the reference keywords bid as the basis for the associated location-based keyword bids. Each location-based structure has a bid multiplier associated with it and when the system locates keywords within a given location-based structure it may refer to the map to determine the bid multiplier to apply to the keyword. Once the correct multiplier is located the system 1000 may find the reference keyword bid and multiply it by the set multiplier to determine the necessary bid for the location-based keyword.

If it is determined in step S215 that a reference bid override does exist, the location-based keyword bid is set by using the bid override value and the map multiplier. The system may use the set override value as the basis for the associated location-based keyword bids. Each location-based structure has a bid multiplier associated with it and when the system 1000 locates keywords within a given location-based structure it may refer to the map to determine the bid multiplier to apply to the keyword. With the multiplier, the system 1000 may use the set bid override value and set the location-based bid accordingly.

In step S221, it is determined whether the average position is 1.0. In this step, the system 1000 may check to see if the bid of the location-based keyword puts it into an average position of 1.0. If so, the system 1000 may try to find a more efficient bid to attain similar outcomes by lowering the bid until the average position becomes 1.1, at which point the process ends at step S225.

If it is determined in step S221 that the average position is not 1.0, the process ends at step S225.

FIG. 15 is a block flow diagram showing a positional buying algorithm according to an exemplary embodiment of the present invention. The positional buying algorithm primarily uses the designated map 5020 to determine the average position (i.e., the average relative position compared to other displayed ads) in which each of the cloned keywords 5040 from respective cloned structures 5030 should reside. The positional algorithm may use the reference keywords bid and average position 5012 in the position logic 5060. Based on what positional algorithm is currently in use, the system 1000 may purely use the defined average position that is set with the map 5020 and set each cloned keywords max bid to a value that is required to achieve the expected average position 5052. The algorithm may also use the reference keywords current average position 5054 to inform the algorithm of the available average positions 5050 that can be applied to the number of defined regions within the map, spreading each sector and cloned keywords across the available positions by adjusting their max bids accordingly.

FIG. 16 is a flow chart showing a positional buying algorithm according to an exemplary embodiment of the present invention. In this embodiment, the buying algorithm proceeds as it reads what average position is set in the map the user is currently using. The process starts in step S301 and proceeds to step S303 where, for each keyword, the media sources is queried to determine highest available position. For each of the keywords that are running, the system 1000 may query the media source (e.g., Google) to find the minimal bid needed to serve the ad and the average position it will serve in.

In step S305, the media source is queried to attain average position and bid. In this step, an API, an automated means or manual method may be used to determine the current bid and position of a given keyword.

In step S307, it is determined whether the set bid is eligible to serve the ad. In particular, this section of the flow chart attempts to determine what is the lowest possible bid and average position that can be bid for. To discover what that is, a keyword's bid is lowered until it is no longer eligible to serve because the bid is too low. Once the last known eligible bid and average position are known, the system then knows how many available positions there really are in the given keywords landscape and based on the map, distribute the defined segments across those positions. In this step, through automated means or a manual method, the keyword under investigation is checked to determine whether it is currently eligible to be shown with it's current bid. If eligible, process flows to step S309, where the keyword bid is lowered and then back to step S305 until the keyword is not eligible to be shown. In this regard, automated or manual methods may be used to lower the keywords bid and then the process may loop back to step S305 to verify if the keyword's ad's are still eligible to be shown and what is the expected average position.

If it is determined in step S307 that the set bid is eligible to serve the ad, then process flows to step S311, where previous known bid and expected average position data are used for determining location-based bids. Once the minimal bid needed to show the ad for the given keyword is determined, this information can be used to determine what the necessary bids are for all of the location-based keywords.

In step S313, based on the map, desired average position for all segments is determined using the known bids and position information. In this step, based on the map the system 1000 will determine each groups desired position as well as the reference keywords position. The desired positions and subsequent bids will move the reference keyword into the average position and base all of the subsequent “hot” position keywords from the reference average position −0.1 down to average position 1.0. All “cool” segments will be positioned from the average position +0.1 up to the maximum available position determined in step S311. In this regard, “hot” segments are areas within the map that are calculated to contain better than the average audience, based on a given maps targeting parameters and “cool” “segments are areas that are calculated to contain less than the average audience parameters.

In step S315, each segment is set to the necessary bids to achieve desired positions. In this step, based on the results of step S313, the necessary bids are set to achieve calculated average positions. The process then ends at step S317.

FIG. 17 is a flow chart showing a positional buying algorithm according to another exemplary embodiment of the present invention. In this embodiment, the position buying algorithm queries the media provider to find the average position of the reference keyword to determine the available average positions the system 1000 can apply to the cloned keywords.

In step S401, the process begins and proceeds to step S403, where the average position time segment to use is determined. In this step, the system 1000 may read a variable that is either set by the user or a system default. The variable setting can be any time range between the previous hour and the previous year. The variable tells the system 1000 what average position time frame is needed to figure out the reference keywords average position value that is used to determine bids for the regional groupings based on the set map.

In step S405, it is determined whether the segment is set. In this step, the system 1000 may check if the time segment to determine average position is set. If no, the process flows to step S407, where a default value is referenced. The default value may be, for example, the days average position of the reference keyword.

Once the time segment is set, the process flows to step S409, where the reference keywords average position on the set time segment window is queried. In this step, the system 1000 makes a request to the media source, via automated means, to extract each reference keywords average position over the specified time range and decides how to bid on the location-based keywords based on the value returned.

In step S411, it is determined whether the average position is 1.0. In this regard, if the served position of the reference keyword is in position one, for the “hot”, or location-based regions that are higher than the average metric determined by the associated map, the system 1000 may set all of the location-based keywords equal to the reference bid, since there is no opportunity to bid higher and would only waste marketing budget.

If it is determined in step S411 that the average position is 1.0, the process flows to step S413 where all “hot” segments bids are set equal to the reference keyword bid. As a result of this step, all of the above average location-based segments will be bid the same as the reference keyword since there is no opportunity for the additional bid cost.

If it is determined in step S411 that the average position is not 1.0, the process flows to step S415, where, based on the map, “hot” segment bids are set to cover available average positions. In this step, the system 1000 may use the reference keyword's average position as the ceiling position for the “hot” location-based segments. Once the ceiling average position has been determined, the system 1000 may look at the number of “hot” segments based on the map and determine what average position each segment should fill and will set the bid accordingly down to position 1.0.

To have a keyword achieve an average position the system 1000 may query the media source to determine the location-based keywords current average position. If the average position is where it needs to be no bid change is required. If it is higher, greater than the position it needs to be in, the system 1000 may raise the max bid and query the media source to determine if the average position based on the new bid is where it needs to be, and if not the system 1000 may continue to raise the bid again and check position until the desired position is achieved. If it is lower, below the desired position, the system 1000 may lower the bid and query the media source until the desired position is achieved.

In step S417, based on the map, “cool” segment bids are set to cover available positions. In this step, the system 1000 may use the reference keyword's average position as the base position for the “cool” location-based segments. Once the base average position has been determined, the system 1000 may determine the highest available average position by bidding the minimum bid amount to determine the average position of the highest, least valuable position. Once the ceiling position is established the system 1000 may determine each of the “cool” segments required average position based on the map and the available positions between the base and the ceiling. The system 1000 may then bid each location-based segment as discussed in step S415 to achieve the desired average position. The process then ends at step S419.

Now that embodiments of the present invention have been shown and described in detail, various modifications and improvements thereon will become readily apparent to those skilled in the art. Accordingly, the spirit and scope of the present invention is to be construed broadly not limited by the foregoing specification.

What is claimed is:

1. A method for modifying bids on keywords used in targeted advertising, comprising:
generating by one or more computers a data map made up of data representing spatially sorted information related to attributes of a plurality of users of electronic devices each located at a respective location within a space and used to access electronic media;
receiving from a user computer a bid amount on an opportunity to display an advertisement through the electronic media; and
automatically adjusting by the one or more computers the bid amount for each location so that display of the advertisement through the electronic media is spatially optimized based on the spatially sorted information provided by the data map.

2. The method of claim 1, further comprising the step of providing the adjusted bid amount to the user computer.

3. The method of claim 1, further comprising the step of providing the adjusted bid amount to a media provider that displays the advertisement.

4. The method of claim 1, wherein the electronic media is accessible through the Internet.

5. The method of claim 1, wherein the electronic media is accessible through a set top box.

6. The method of claim 1, wherein the attributes of the plurality of users comprise attributes selected from the group consisting of: demographic attributes, psychographic attributes and behavioral attributes.

7. The method of claim 1, wherein the information represented by the data map is geospatially sorted.

8. The method of claim 1, wherein the information represented by the data map is spatially sorted based on network addresses within a computer network.

9. The method of claim 1, wherein the spatially sorted information relates to a single temporal coordinate set.

10. The method of claim 1, wherein the step of generating a data map comprises generating the data by searching through the locations and generating the data at each searched location.

11. The method of claim 1, wherein the step of generating a data map comprises generating the data based on an incoming data stream of variables used to generate the data.

12. The method of claim 1, wherein the step of generating a data map comprises:
generating a raw data map by generating a first subset of the data corresponding to the locations within the space where direct measurement of variables used to generate the data is available;
generating a second subset of the data corresponding to the locations within the space where direct measurement of variables used to generate the data is not available by estimating the second subset of the data based on the first subset; and
combining the first subset and the second subset of the data.

13. The method of claim 12, wherein the second subset of the data is estimated using near neighbor averaging of the first subset of the data.

14. The method of claim 12, wherein the second subset of the data is estimated using binary sample cross validation.

15. The method of claim 12, wherein the second subset of the data is estimated using time series estimation.

16. The method of claim 1, wherein the locations are defined based on coordinates within the space.

17. The method of claim 1, wherein the locations are based on ZIP codes, cities, towns, counties, states, countries or combinations thereof.

18. The method of claim 1, wherein the step of adjusting comprises:
determining a multiplier at each location based on the data map; and
for each location, applying the respective multiplier to the bid amount.

19. The method of claim 18, wherein the step of adjusting further comprises, for each location, modifying the bid amount so as to obtain a desired average placement position for the advertisement at the location.

20. The method of claim 1, wherein the step of adjusting comprises:
for each location, modifying the bid amount so as to obtain a desired average placement position for the advertisement at the location based on the average placement position of the bid amount prior to adjustment.

21. A system for modifying bids on keywords used in targeted advertising, comprising:
a memory unit;
one or more processors; and
a computer-readable storage medium coupled to the one or more processors having instructions stored thereon which, when executed by the one or more processors, cause the one or more processors to perform a method comprising:
generating by one or more computers a data map made up of data representing spatially sorted information related to attributes of a plurality of users of electronic devices each located at a respective location within a space and used to access electronic media;
receiving from a user computer a bid amount on an opportunity to display an advertisement through the electronic media; and
automatically adjusting by the one or more computers the bid amount for each location so that display of the advertisement through the electronic media is spatially optimized based on the spatially sorted information provided by the data map.
